(19) United States
(12) Patent Application Publication
(10) Pub. No.: US 2025/0369409 A1
(43) Pub. Date: Dec. 4, 2025

(54) ELECTRIC IN-TANK FUEL PUMPS WITH CONFIGURABILITY FOR SUPPORTING DIFFERENT FUEL PRESSURES

(71) Applicant: Illinois Tool Works Inc., Glenview, IL (US)

(72) Inventor: Nathan Joe Jochman, Neenah, WI (US)

(21) Appl. No.: 19/191,250

(22) Filed: Apr. 28, 2025

Related U.S. Application Data
(60) Provisional application No. 63/652,455, filed on May 28, 2024.

(51) Int. Cl. F02M 37/10; F02M 37/32; F02M 69/02; F02M 69/54; F02M 71/00

(52) U.S. Cl. CPC F02M 37/10; F02M 37/32; F02M 69/02; F02M 69/54; F02M 71/00

(57) ABSTRACT

Systems and methods are provided for electric in-tank fuel pumps with configurability for supporting different fuel pressures. An example welding-type system may include an engine that uses liquid fuel to generate mechanical power, a generator configured to convert mechanical power from the engine to electric power for use in driving one or more components of the welding-type system, and a fuel delivery component that supplies the liquid fuel to the engine from a fuel tank. The fuel delivery component may include a fuel pump. The fuel pump may be disposed within the fuel tank. The fuel pump may be configurable to supply the fuel at a plurality of pressure levels that may include, at least, a first pressure level and a second pressure level that is different from the second pressure level.

### CLAIM OF PRIORITY

This patent application claims priority to and claims benefit from U.S. Provisional Patent Application Ser. No. 63/652,455, filed May 28, 2025. The above identified application is hereby incorporated herein by reference in its entirety.

### BACKGROUND

Welding has become increasingly ubiquitous. Welding can be performed in an automated manner or in a manual manner (e.g., being performed by a human). Various equipment or components may be used during welding operations. For example, in some instances engines may be used in conjunction with welding operations, particularly to provide driving power (e.g., mechanical power) that is used in driving other components, such as generators which may be used in turn to provide electric power to other components used during the welding operations.

Conventional welding solutions may have some limitations and/or disadvantages, however. For example, use of engines (particularly in conjunction with use of generators) in conventional welding solutions may have limitations and/or disadvantages with respect to ease of use, cost, reliability, and the like. Further limitations and disadvantages of conventional approaches will become apparent to one skilled in the art, through comparison of such approaches with some aspects of the present systems and methods set forth in the remainder of this disclosure with reference to the drawings.

### BRIEF SUMMARY

Aspects of the present disclosure relate to welding solutions. More specifically, various implementations in accordance with the present disclosure are directed to systems and methods for electric in-tank fuel pumps with configurability for supporting different fuel pressures, substantially as illustrated by or described in connection with at least one of the figures, and as set forth more completely in the claims.

These and other advantages, aspects and novel features of the present disclosure, as well as details of an illustrated implementation thereof, will be more fully understood from the following description and drawings.

### BRIEF DESCRIPTION OF THE DRAWINGS

FIG. 1 shows an example welding-type setup that may be used for welding-type operations.

FIG. 2 shows an example portable generator with fuel delivery system that may incorporate in-fuel tank pumping, for use in welding-type setups.

FIG. 3 shows an example in-fuel tank pump block diagram.

FIG. 4 shows a fuel tank with an example in-fuel tank pump system configurable to support different fuel pressures.

### DETAILED DESCRIPTION

As utilized herein, the terms “circuits” and “circuitry” refer to physical electronic components (e.g., hardware), and any software and/or firmware (“code”) that may configure the hardware, be executed by the hardware, and/or otherwise be associated with the hardware. As used herein, for example, a particular processor and memory (e.g., a volatile or non-volatile memory device, a general computer-readable medium, etc.) may comprise a first “circuit” when executing a first one or more lines of code and may comprise a second “circuit” when executing a second one or more lines of code. Additionally, a circuit may comprise analog and/or digital circuitry. Such circuitry may operate, for example, on analog and/or digital signals. It should be understood that a circuit may be in a single device or chip, on a single motherboard, in a single chassis, in a plurality of enclosures at a single geographical location, in a plurality of enclosures distributed over a plurality of geographical locations, etc. Similarly, the term “module” may, for example, refer to a physical electronic components (e.g., hardware) and any software and/or firmware (“code”) that may configure the hardware, be executed by the hardware, and/or otherwise be associated with the hardware.

As utilized herein, circuitry or module is “operable” to perform a function whenever the circuitry or module comprises the necessary hardware and code (if any is necessary) to perform the function, regardless of whether performance of the function is disabled or not (e.g., by a user-configurable setting, factory trim, etc.).

As utilized herein, “and/or” means any one or more of the items in the list joined by “and/or”. As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y, and z.” As utilized herein, the term “exemplary” means serving as a non-limiting example, instance, or illustration. As utilized herein, the terms “for example” and “e.g.” set off lists of one or more non-limiting examples, instances, or illustrations.

Welding-type power, as used herein, refers to power suitable for welding, plasma cutting, induction heating, CAC-A (carbon arc cutting/air) and/or hot wire welding/preheating (including laser welding and laser cladding). Welding-type power supply, as used herein, refers to a power supply that can provide welding-type power. A welding-type power supply may include power generation components (e.g., engines, generators, etc.) and/or power conversion circuitry to convert primary power (e.g., engine-driven power generation, mains power, etc.) to welding-type power.

Welding-type operations, as used herein, comprise operations in accordance with any known welding technique, including flame welding techniques such as oxy-fuel welding, electric welding techniques such as shielded metal arc welding (e.g., stick welding), metal inert gas welding (MIG), tungsten inert gas welding (TIG), resistance welding, as well as gouging (e.g., carbon arc gouging), cutting (e.g., plasma cutting), brazing, induction heating, soldering, and/or the like.

Welding-type setup, as used herein, refers to any setup comprising welding related devices or equipment (e.g., welding power sources, welding torch, welding gear such as headwear and the like, auxiliary devices or systems, etc.) which are used in facilitating and/or in conjunction with welding-type operations.

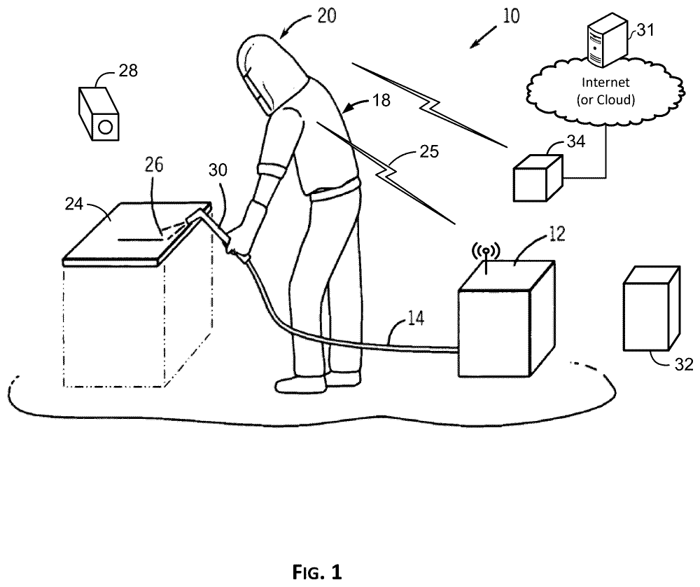

FIG. 1 shows an example welding-type setup that may be used for welding-type operations. Referring to FIG. 1, there is shown an example welding-type setup 10 in which an operator (user) 18 is wearing headwear 20 and welding a workpiece 24 using a torch 30 to which power is delivered by equipment 12 via a conduit 14, with weld monitoring equipment 28, which may be available for use in monitoring welding operations.

The equipment 12 may comprise a power source, optionally a source of a shield gas and, where wire/filler material is to be provided automatically, a wire feeder. Further, in some instances an engine 32 may be used to drive equipment or components used during welding operations. The engine 32 may comprise a gas engine a liquefied petroleum (LP) engine, or a diesel engine. The engine 32 may drive generators, power sources, etc. used during welding operations.

The welding-type setup 10 of FIG. 1 may be configured to form a weld joint by any known welding-type technique. For example, optionally in any implementation, the welding equipment 12 may be arc welding equipment that provides a direct current (DC) or alternating current (AC) to a consumable or non-consumable electrode of a torch 30. The electrode delivers the current to the point of welding on the workpiece 24. In the welding-type setup 10, the operator 18 controls the location and operation of the electrode by manipulating the torch 30 and triggering the starting and stopping of the current flow. In other implementations, a robot or automated fixture may control the position of the electrode and/or may send operating parameters or trigger commands to the welding system. When current is flowing, an arc 26 is developed between the electrode and the workpiece 24. The conduit 14 and the electrode thus deliver current and voltage sufficient to create the electric arc 26 between the electrode and the workpiece. The arc 26 locally melts the workpiece 24 and welding wire or rod supplied to the weld joint (the electrode in the case of a consumable electrode or a separate wire or rod in the case of a non-consumable electrode) at the point of welding between electrode and the workpiece 24, thereby forming a weld joint when the metal cools.

Optionally in any implementation, the weld monitoring equipment 28 may be used to monitor welding operations. The weld monitoring equipment 28 may be used to monitor various aspects of welding operations, particularly in real-time (that is as welding is taking place). For example, the weld monitoring equipment 28 may be operable to monitor arc characteristics such as length, current, voltage, frequency, variation, and instability. Data obtained from the weld monitoring may be used (e.g., by the operator 18 and/or by an automated quality control system) to ensure proper welding.

As shown, the equipment 12 and headwear 20 may communicate via a link 25 via which the headwear 20 may control settings of the equipment 12 and/or the equipment 12 may provide information about its settings to the headwear 20. Although a wireless link is shown, the link may be wireless, wired, or optical.

Optionally in any implementation, equipment or components used during welding operations may be driven using engines. For example, the engine 32 may drive generators, power sources, etc. used during welding operations. In some instances, it may be desired to obtain information relating to used engines. For example, data relating to engines (and operations thereof) used during welding operations may be collected and used (e.g., based on analysis thereof) in monitoring and optimizing operations of these engines. The collection and use of such data may be performed telematically—that is, the data may be collected locally, subjected to at least some processing locally (e.g., formatting, etc.), and then may be communicated to remote management entities (e.g., centralized management locations, engine providers, etc.), using wireless technologies (e.g., cellular, satellite, etc.).

Optionally in any implementation, a dedicated controller (e.g., shown as element 34 in FIG. 1) may be used to control, centralize, and/or optimize data handling operations. The controller 34 may comprise suitable circuitry, hardware, software, or any combination thereof for use in performing various aspects of the engine related data handling operations. For example, the controller 34 may be operable to interface with the engine 32 to obtain data related thereto. The controller 34 may track or obtain welding related data (e.g., from weld monitoring equipment 28, from equipment 12, etc.). The controller 34 may then transmit the data (e.g., both engine related and weld related data), such as to facilitate remote monitoring and/or management, by way of wireless communications. This may be done using cellular and or satellite telematics hardware, for example.

In some example implementations, welding-type systems or setups, such as the welding-type setup 10, may be configured for collecting and reporting data relating to welding-type operations and/or to functions or components utilized during welding-type operations. For example, data from welding processes, power sources, welding-related accessories etc. in a weld setup may be collected. In this regard, the collected data may comprise, for example, current, voltage, wire feed speed, weld states, and numerous other power source parameters and settings.

The collected data may then be sent to remote entities (e.g., a remote server 31, which may be a manufacturer-controlled, Internet-based cloud server) and/or to local systems or devices (e.g., local PC, a tablet, a smartphone, etc.). The collected data may be utilized in enhancing welding-related systems and/or operations. For example, manufacturers may utilize the collected data to identify issues (and correct them) and/or devise modifications or improvements in the various components. Further, users may be able to generate reports on collected data to measure, document, and improve their processes.

Improving or enhancing operation of the various components of welding-type setups, such as the welding-type setup 10 of FIG. 1, is desirable. Such improvements or enhancements may be achieved by improving or enhancing particular components of welding-types setups.

Improving or enhancing operation of the various components of welding-type setups, such as the welding-type setup 10 of FIG. 1, is desirable. Such improvements or enhancements may be achieved by improving or enhancing particular components of welding-types setups. For example, as noted in many welding-type setups a generator may be used, with such generator being utilized to supply power to various components in welding-type setup. In many instances, such generators may be driven by an engine (e.g., the engine 32 in the welding-type setup 10). Typically such engines are configured to generate mechanical power, for driving the generators, based on combustion of some type of fuel. Example engines that may be used include gas engines, liquefied petroleum (LP) engines, diesel engines, and the like. As such, the welding-type setup may incorporate s fuel system configured to provide fuel to engine(s) used therein. In this regard, such fuel system may comprise a fuel delivery system configured to deliver fuel to the engine(s) from associated fuel storage components (e.g., fuel tanks).

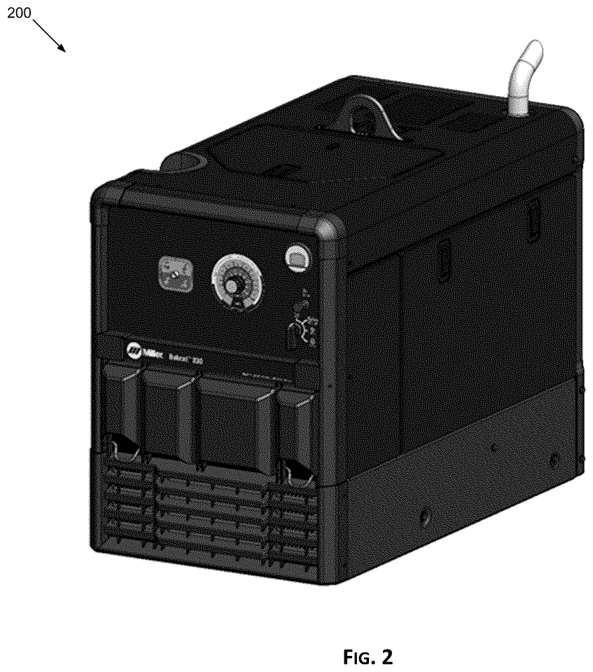

In some instances, to enhanced operation of welding-type setups, various components may be designed to allow for portability of such components, and/or for enhancing of any such portability. For example, in some instances a portable generator may be used. Further, in some implementations such portable generator may be designed and/or implemented with the generator and other related components—e.g., the engine(s) and the fuel system(s) associated therewith-being enclosed within a single housing. In other words, a portable generator may be a single box that houses the generator, the engine, and the associated fuel system (e.g., the fuel tank and the fuel delivery system). An example of such portable generator is illustrated in FIG. 2.

Enhancing usability and reliability of generators and related components may improve performance of welding-type setups as a whole, and of welding-type operations performed therein in particular. Such enhancements may be achieved by addressing shortcomings in existing generators. For example, conventional solutions may be improved upon by, e.g., enhancing features and/or functions relating to the fuel delivery mechanism and systems, particularly in portable generator based implementations.

In this regard, fuel systems in enclosed generators or welder/generators may typically have pumps to move fuel from the fuel tank to the engine. These pumps are located between the fuel tank and engine, and are used in pumping the fuel form the fuel tank to the engine. Such pumps may have some issues and shortcomings, however. For example, in many instances the pumps may cause running issues due to the system's inability to handle wide environmental conditions (e.g., heat from engine, ambient conditions, etc.), which may affect fuel delivery. Further, such issues may affect different types of engines differently. In this regard, common engine options include carbureted and electronic fuel injected (EFI) engines. However, fuel pressures vary considerably between carbureted and EFI engines, with carbureted engines requiring, e.g., 3 to 5 psi of fuel delivery while EFI engines requiring, e.g., about 40 psi fuel delivery.

In various implementations based on the present disclosure, performance of fuel systems used in welding-type setups (particularly, e.g., in portable generators) may be enhanced. This may be done by, e.g., moving the fuel pumps inside the fuel tanks. In this regard, doing so may be beneficial for different types of engines that may be used. For example, both engine options noted herein (carbureted and EFI engines) may benefit from moving the fuel pump inside the fuel tank, particularly to reduce vapor lock issues with pumps in hot enclosures. As such, implementations based on the present disclosure may offer a modular approach to fuel delivery that allows an in-fuel tank pump assembly to be set up for low pressure delivery or high-pressure delivery of fuel to the engine.

In various example implementations, a fuel pump module capable of supporting different pressures, including at least a high pressure, may be placed inside a fuel tank. The fuel pump module may have the capability to produce a high pressure based fuel supply when a high pressure fuel pressure regulator is installed, and a low pressure fuel supply when a low fuel pressure regulator is installed. The fuel pump module may be capable of and designed for high pressure based setup (e.g., a setup incorporating an electronic fuel injected (EFI) based engine). However, the fuel pump module may be modified for operation in low pressure based setup (e.g., a setup incorporating a carbureted based engine). To convert the high pressure assembly to a low pressure assembly, a different fuel pressure regulator may be installed. This configuration would be done at the assembly factory and the pump assembly provided in either a high pressure or low pressure configuration. Since the fuel pressure regulator controls the fuel output pressure, changing the pressure setting of the regulator produces different controlled outlet fuel pressures. For example, a fuel pressure regulator for EFI based setups would be set to a value above 10 psi (usually 40 psi) and a fuel pressure regulator for carbureted would be set for a value below 10 psi (usually around 3 to 5 psi.

Example implementations based on the present disclosure are described in more detail below.

FIG. 2 shows an example portable generator with fuel delivery system that may incorporate in-fuel tank pumping, for use in welding-type setups. Referring to FIG. 2, there is shown a portable generator 200 that may be configured for use in welding-type setups.

The portable generator 200 may be configured to provide power to one or more components in a welding-type setup (e.g., the welding-type setup 10). In this regard, as noted above, generators typically may be driven by engines or the like, and while such engines may be external and separate components, in some instances the generator may be combined with the engine(s) (or other component(s) driving the generator), as well as other components such as fuel system(s), into a single box for ease of use and portability.

For example, as illustrated in FIG. 2, the portable generator 200 may incorporate an engine (not shown) that is used to drive the generator components used in generating power, as well as a fuel system for providing fuel to the engine, with the fuel system comprising, e.g., a fuel storage component (e.g., a fuel tank) and a fuel delivery system for facilitating delivery of fuel from the fuel storage component to the engine. The engine may comprise a gas engine, a liquefied petroleum (LP) engine, a diesel engine, or the like. The fuel delivery system may comprise a pump configured to pump fuel from the fuel tank into the engine. In conventional solutions, the fuel delivery system is disposed between the fuel tank and the engine, and external to the fuel tank. However, as noted such designs may have shortcoming, particularly with respect to the effects of environmental conditions (e.g., heat from engine, ambient conditions, etc.) on fuel delivery. In solutions based on the present disclosure, such shortcomings may be addressed such as by moving the fueling delivery system, or at least portion thereof (namely the pump or pumping component) within the fuel tank.

Examples of such fuel delivery systems, with in-fuel tank pumping, are described in more detail below.

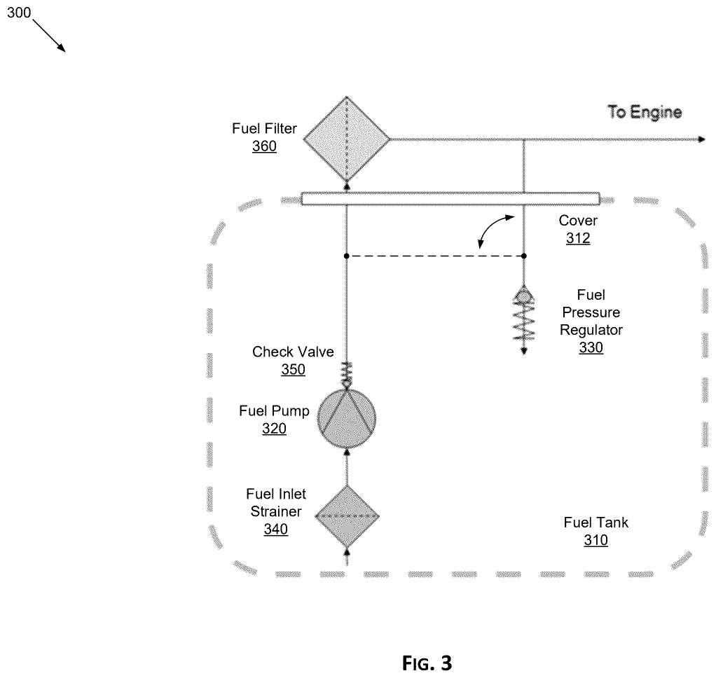

FIG. 3 shows an example in-fuel tank pump block diagram. Referring to FIG. 3, there is shown fuel system 300 (or simplified schematic block diagram thereof). The fuel system 300 incorporates in-fuel tank pumping implemented based on the present disclosure.

As illustrated in FIG. 3, the fuel system 300 comprises a fuel tank 310, having a cover 312. The fuel system 300 further comprises one or more components configured to facilitate delivery or supply of fuel from the fuel tank 310 (e.g., to an engine associated with the fuel tank 310). These one or more components constitute a fuel delivery system. For example, as illustrated in FIG. 3, the fuel system 300 comprises a fuel pump 320, a fuel pressure regulator 330, a strainer 340, and a check valve 350. These component are disposed within the fuel tank 310. The fuel system 300 may also comprise a fuel filter 360 disposed external to the fuel tank 310, and providing filtering of fuel after being output from fuel tank but before being supplied (e.g., to the engine). As such, the fuel delivery system of the fuel system 300 comprises all these components—that is, the fuel pump 320, the fuel pressure regulator 330, the strainer 340, the check valve 350, and the fuel filter 360.

The fuel pump 320 is configured to pump fuel from the fuel tank 310. In accordance with the present disclosure, the fuel pump 320 is disposed within the fuel tank 310. Further, the fuel pump 320 is configurable to supply the fuel at a plurality of pressure levels. The pressure levels may correspond to, e.g., different types of engines, different fuel injection technique, different operating conditions, etc., or any combinations of such factors.

For example, the plurality of pressure levels may comprise first pressure level and a second pressure level that is different from the second pressure level. In this regard, the first pressure level may be, e.g., a low-pressure delivery requirement associated with a first type of fuel injection technique, whereas the second pressure level may be, e.g., a high-pressure delivery requirement associated with a second type of fuel injection technique. In this regard, the first type of fuel injection technique may be carburetor based fuel injection, whereas the second type of fuel injection technique may be electronic fuel injected (EFI) based fuel injection.

The fuel pressure regulator 330 may be configured to control pressure of fuel delivered in the fuel system 300. In this regard, the fuel pressure regulator 330 may be configured to release at least some of the fuel pumped out by the fuel pump 320, such under certain conditions. For example, the fuel pressure regulator 330 may be configured to release pumped fuel at particular pressure threshold(s). In some instances, such threshold(s) may be preset and fixed; alternatively, in some instances, such threshold(s) may be adjustable and/or may be set dynamically. For example, the fuel pressure regulator 330 may be preset to particular pressure (e.g., at a high pressure level or at a low pressure level). As noted the fuel pump 320 may be capable of supporting different pressures, including at least a high pressure. Thus, the fuel pump 320 may provide (pump) fuel at high pressure when the fuel pressure regulator 330 is a high pressure fuel pressure regulator, and at a low pressure when the fuel pressure regulator 330 is a low fuel pressure regulator. The high pressure configuration may be used in setups (e.g., portable generator) incorporating an electronic fuel injected (EFI) based engine, whereas the low pressure configuration may be used in setups (e.g., portable generator) incorporating a carbureted based engine. While illustrated in FIG. 3 as being connected to the fuel circuit after the fuel filter 360 (e.g., the fuel line delivering fuel to the engine), in some implementations the fuel pressure regulator 330 may be connected to the fuel circuit after the check valve 350 instead. In some instances, the fuel pressure regulator 330 may be selectively deactivated.

In some instances, the fuel pressure regulator 330 may be non-adjustable, and such the fuel pressure regulator 330 may be pre-selected and pre-installed for each configuration (high pressure configuration or low pressure configuration). Alternatively, in some instances, the fuel pressure regulator 330 may be adjustable, and may be set or adjusted for the operation in desired configuration. This configuration would be done at the assembly factory and the pump assembly provided in either a high pressure or low pressure configuration. Since the fuel pressure regulator controls the fuel output pressure, changing the pressure setting of the regulator produces different controlled outlet fuel pressures. For example, a fuel pressure regulator for EFI based setups would be set to a value above 10 psi (usually 40 psi) and a fuel pressure regulator for carbureted would be set for a value below 10 psi (usually around 3 to 5 psi

The strainer 340 and the fuel filter 360 are configured to provide filtering of fuel being delivered by the fuel system 300, with the strainer 340 providing filtering of fuel within the fuel tank 310 as the fuel is ingested into the fuel pump 320 (that is, at point of intake), whereas the fuel filter 360 provides filtering of fuel as it is output from fuel tank 310 (but before being supplied, e.g., to the engine).

The check valve 350 may be configured to provide fuel drainage control—e.g., preventing fuel drainage, such as when the fuel pump 320 is not operating. In some instances, the check value 340 may be selectively deactivated.

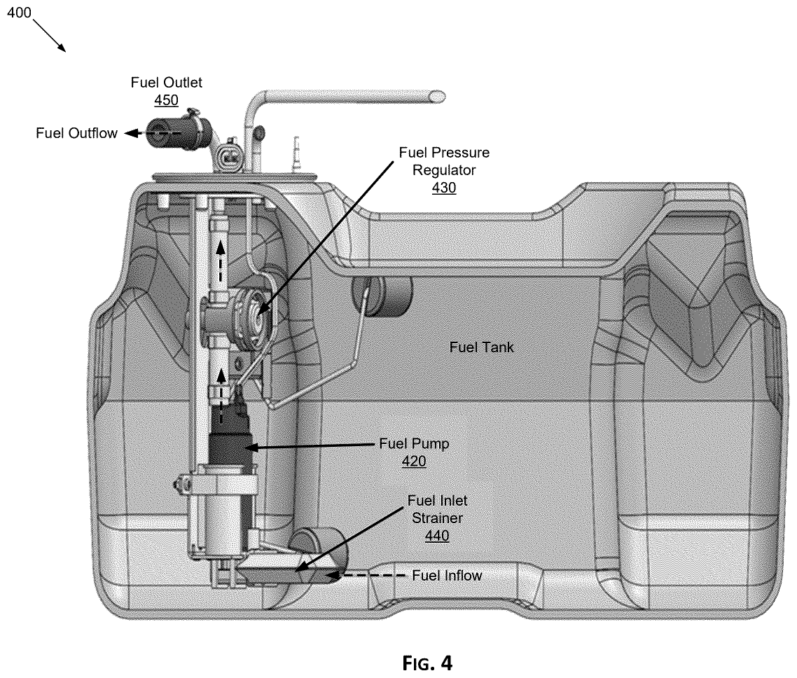

FIG. 4 shows a fuel tank with an example in-fuel tank pump system configurable to support different fuel pressures. Referring to FIG. 3, there is shown fuel tank 400 (cross-section thereof) that incorporates in-fuel tank pumping implemented based on the present disclosure.

The fuel tank 400 may represents an example embodiment incorporating fuel system similar to the fuel system described with respect to FIG. 3. As illustrated in FIG. 4, the fuel tank 400 comprises fuel pump 420, a fuel pressure regulator 430, a fuel intake strainer 440, and fuel outlet 450. In this regard, the fuel pump 420, a fuel pressure regulator 430, a fuel intake strainer 440, and a fuel outlet 450 may be substantially similar to, and may operate in substantially similar manner as the fuel pump 320, a fuel pressure regulator 330, and the fuel intake strainer 340, as described with respect to FIG. 3. As such, the fuel pump 420 may be may be configured to provide (pump) fuel from the fuel tank 400 at particular pressure level, which may be controlled by the fuel pressure regulator 430. In this regard, the fuel pressure regulator 430 may be configured to allow high pressure fuel supply (e.g., when the fuel tank 400 is used in an EFI engine) or low pressure fuel supply (e.g., when the fuel tank 400 is used in a carbureted engine). The pumped fuel is output via the fuel outlet 450.

In some example implementations, fuel systems implemented based on the present disclosure, may be configured to use different pressure levels, such as, e.g., two different pressure levels: one pressure for EFI engines and a second lower pressure for carbureted engines. Such alternative approach may be used in fuel systems substantially similar to the ones described herein (e.g., same system 300 of FIG. 3), except that a pressure sensor is added to the system after the check valve, and the fuel pressure regulator is removed. This alternative approach entails an active control of the pump fuel (e.g., a pump motor), such as to change the pump speed so that the fuel pump produces a target pressure. The pressure sensor may be configured to measure system pressure for use in controlling the pump motor. The measured system pressure may be provided to a controller (comprising suitable circuitry), which in turn would drive the pump motor to match the desired pressure—e.g., either the high pressure (for EFI engines) or the low pressure (for carbureted engines). In other words, this alternative approach employs an active control loop using the feedback of the pressure sensor. For example, if the engine starts using more fuel, the controller would sense a pressure reduction and in turn increase the pump speed to get back to target pressure. Similarly if the pressure is sensed high, the controller reduces the pump speed to get back to target pressure. The controller may be any suitable controller, including readily available ones such as pulse-width modulation (PWM) controllers.

Such alternative approach may be particularly utilized for particular types of pumps. For example, where the fuel pump is an impeller type, the pressure-flow characteristic is a curve at any given speed. The curves change with speed and so the speed control of the pump can be controlled to regulate a pressure as long as it's within the pump's capability. The exact speed of the pump may not be needed as the control loop is driving to a target pressure. Since the user (welder) may be able of identifying which engine is in the unit, the user may set the target pressure accordingly and not need an external input or adjustment of the fuel system. As such, this alternative approach may have the benefit of providing a single fuel system that is commanded by a controller to produce two different pressures thus reducing the need to manually or mechanically configure a pressure regulator.

Accordingly, solutions based on the present disclosure may have offer various advantages, particularly compared to conventional solutions. The advantages may include: 1) allowing for use of similar components for different engines/setups (e.g., for both EFI and carbureted engines/setups), 2) allowing for a high reliability EFI style pump to be used on carbureted engines, and 3) maintaining all the advantages of an in-fuel tank fuel pump. All the advantages of an in-fuel tank fuel pump are achieved for both EFI and carbureted engines since the overall fuel system is identical except the fuel pressure.

Solutions based on the present disclosure may eliminate or mitigate various issues or shortcomings, particularly ones associated with conventional solutions. For example, fuel systems based on the present disclosure may eliminate fuel vapor lock conditions by minimizing fuel temperature and maximizing pump head pressure by submerging the high pressure pump in the fuel. Fuel in the fuel system is at high pressure all the way to the engine and will not vaporize because of the high pressure. Therefor the engine always receives an adequate fuel supply at the correct pressure for continued operation at high temperatures or in tight enclosures. Fuel systems based on the present disclosure may also eliminate multiple fuel pumps needed to supply the engine. In this regard, typically when a high pressure pump is on the engine, it is needed to be supplied fuel by another pump. Such second pump may be eliminated when using fuel systems based on the present disclosure, which further improves and simplifies the fuel system.

Further, solutions based on the present disclosure may allow for pressure regulation in the fuel tank which reduces fuel inlet temperatures in the pump. In this regard, when the high pressure pump is on the engine, inlet fuel is recirculated from the regulator back to the fuel pump inlet quickly and repeatedly as needed causing a large increase in fuel inlet temperatures and vaporization.

Further, solutions based on the present disclosure may remove excessive vibration from the pump. When the high pressure pump is on the engine, vibration adds to fuel vaporization and vapor lock.

Further, solutions based on the present disclosure may eliminate the need to control vapors in a second location. When mounted on the engine, the high pressure fuel system needs a vapor vent to prevent the pump from vapor locking. This secondary vent system is eliminated when the pump is incorporated in the fuel tank.

An example welding-type system, in accordance with the present disclosure, comprises an engine that uses liquid fuel to generate mechanical power, a generator configured to convert mechanical power from the engine to electric power for use in driving one or more components of the welding-type system, and a fuel delivery component that supplies the liquid fuel to the engine from a fuel tank. The fuel delivery component comprises a fuel pump, with the fuel pump disposed within the fuel tank. The fuel pump is configurable to supply the fuel at a plurality of pressure levels that comprises, at least, a first pressure level and a second pressure level that is different from the second pressure level.

In an example embodiment, each of the first pressure level and the second pressure level correspond to a particular fuel injection technique.

In an example embodiment, the first pressure level corresponds to a low-pressure delivery requirement associated with a first type of fuel injection technique.

In an example embodiment, the first type of fuel injection technique is carburetor based fuel injection.

In an example embodiment, the low-pressure delivery requirement for the carburetor based fuel injection is 3 to 5 psi of fuel delivery.

In an example embodiment, the second pressure level corresponds to a high-pressure delivery requirement associated with a second type of fuel injection technique.

In an example embodiment, the second type of fuel injection technique is electronic fuel injected (EFI) based fuel injection.

In an example embodiment, the high-pressure delivery requirement for the electronic fuel injected (EFI) based fuel injection is about 40 psi of fuel delivery.

In an example embodiment, the fuel delivery component further comprises a fuel pressure regulator configured to regulate or set pressure level of fuel flow from the fuel pump.

In an example embodiment, the fuel pressure regulator configured to lower the pressure level of the fuel flow by releasing or evacuating a portion of the fuel outputted by the fuel pump back into the fuel tank.

In an example embodiment, the fuel delivery component further comprises a fuel pressure regulator configured to regulate or set the pressure level of the fuel flow to a particular pressure level from the plurality of pressure levels.

In an example embodiment, the fuel pressure regulator is adjusted to regulate or set the pressure level of the fuel flow to the particular pressure level.

In an example embodiment, the fuel pressure regulator is adjusted to regulate or set the pressure level of the fuel flow by mechanical means.

In an example embodiment, the fuel delivery component further comprises a check valve configured to provide fuel drainage control.

In an example embodiment, the fuel delivery component further comprises a strainer configured to strain the fuel before ingestion into the fuel pump.

In an example embodiment, the fuel delivery component further comprises a fuel filter configured to filter the fuel pumped from the fuel pump before supply into the engine.

In an example embodiment, the fuel filter is disposed external to the fuel tank.

In an example embodiment, the engine comprises a gasoline engine, a liquefied petroleum (LP) engine, or a diesel engine.

In an example embodiment, the fuel delivery component further comprises a pressure sensor configured to obtain pressure measurements relating to the supplying of the liquid fuel from the fuel delivery component.

In an example embodiment, the fuel delivery component further comprises controller configured to control the fuel pump based on the pressure measurements obtained via the pressure sensor. The controlling may comprise setting or adjusting pump speed of the fuel pump.

Other implementations in accordance with the present disclosure may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the processes as described herein.

Accordingly, various implementations in accordance with the present disclosure may be realized in hardware, software, or a combination of hardware and software. The present disclosure may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

Various implementations in accordance with the present disclosure may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present disclosure has been described with reference to certain implementations, it will be understood by those skilled in the art that various changes may be made and equivalents may be substituted without departing from the scope of the present disclosure. For example, block and/or components of disclosed examples may be combined, divided, re-arranged, and/or otherwise modified. In addition, many modifications may be made to adapt a particular situation or material to the teachings of the present disclosure without departing from its scope. Therefore, it is intended that the present disclosure not be limited to the particular implementation disclosed, but that the present disclosure will include all implementations falling within the scope of the appended claims.

What is claimed is:

1. A welding-type system, comprising:
an engine that uses liquid fuel to generate mechanical power;
a generator configured to convert mechanical power from the engine to electric power for use in driving one or more components of the welding-type system; and
a fuel delivery component that supplies the liquid fuel to the engine from a fuel tank;
wherein the fuel delivery component comprises a fuel pump;
wherein the fuel pump is disposed within the fuel tank;
wherein the fuel pump is configurable to supply the fuel at a plurality of pressure levels that comprises, at least, a first pressure level and a second pressure level that is different from the second pressure level.

2. The welding-type system according to claim 1, wherein each of the first pressure level and the second pressure level correspond to a particular fuel injection technique.

3. The welding-type system according to claim 2, wherein the first pressure level corresponds to a low-pressure delivery requirement associated with a first type of fuel injection technique.

4. The welding-type system according to claim 3, wherein the first type of fuel injection technique is carburetor based fuel injection.

5. The welding-type system according to claim 4, wherein the low-pressure delivery requirement for the carburetor based fuel injection is 3 to 5 psi of fuel delivery.

6. The welding-type system according to claim 2, wherein the second pressure level corresponds to a high-pressure delivery requirement associated with a second type of fuel injection technique.

7. The welding-type system according to claim 6, wherein the second type of fuel injection technique is electronic fuel injected (EFI) based fuel injection.

8. The welding-type system according to claim 7, wherein the high-pressure delivery requirement for the electronic fuel injected (EFI) based fuel injection is about 40 psi of fuel delivery.

9. The welding-type system according to claim 1, wherein the fuel delivery component further comprises a fuel pressure regulator configured to regulate or set pressure level of fuel flow from the fuel pump.

10. The welding-type system according to claim 9, wherein the fuel pressure regulator configured to lower the pressure level of the fuel flow by releasing or evacuating a portion of the fuel outputted by the fuel pump back into the fuel tank.

11. The welding-type system according to claim 9, wherein the fuel pressure regulator is configured to regulate or set the pressure level of the fuel flow to a particular pressure level from the plurality of pressure levels.

12. The welding-type system according to claim 11, wherein the fuel pressure regulator is adjusted to regulate or set the pressure level of the fuel flow to the particular pressure level.

13. The welding-type system according to claim 12, wherein the fuel pressure regulator is adjusted to regulate or set the pressure level of the fuel flow by mechanical means.

14. The welding-type system according to claim 1, wherein the fuel delivery component further comprises a check valve configured to provide fuel drainage control.

15. The welding-type system according to claim 1, wherein the fuel delivery component further comprises a strainer configured to strain the fuel before ingestion into the fuel pump.

16. The welding-type system according to claim 1, wherein the fuel delivery component further comprises a fuel filter configured to filter the fuel pumped from the fuel pump before supply into the engine.

17. The welding-type system according to claim 16, wherein the fuel filter is disposed external to the fuel tank.

18. The welding-type system according to claim 1, wherein the engine comprises a gasoline engine, a liquefied petroleum (LP) engine, or a diesel engine.

19. The welding-type system according to claim 1, wherein the fuel delivery component further comprises a pressure sensor configured to obtain pressure measurements relating to the supplying of the liquid fuel from the fuel delivery component.

20. The welding-type system according to claim 19, wherein the fuel delivery component further comprises controller configured to control the fuel pump based on the pressure measurements obtained via the pressure sensor, and wherein the controlling comprises setting or adjusting pump speed of the fuel pump.
